(19) United States
(12) Patent Application Publication
(10) Pub. No.: US 2001/0032676 A1
(43) Pub. Date: Oct. 25, 2001

(54) Reed valve for engine

(76) Inventors: Kazuhisa Kuroshita, Hyogo-ken (JP); Nagato Sato, Kobe-shi (JP); Atsufumi Ozaki, Kobe-shi (JP)

Correspondence Address: OLIFF & BERRIDGE, PLC, 277 S. WASHINGTON STREET, SUITE 500, ALEXANDRIA, VA, 22314, US

(21) Appl. No.: 09/793,489

(22) Filed: Jun. 12, 2001

(30) Foreign Application Priority Data
Feb. 28, 2000 (JP) 2000-50872

(51) Int. Cl. F16K 15/16

(52) U.S. Cl. 137/512.15; 123/73 V; 137/856

(57) ABSTRACT

A reed valve for opening and closing an intake passage of an engine includes a valve body having a valve hole and a valve seat, and a reed piece made of a resin. The reed piece has a base end of which is supported by the valve body so as to be seated on a valve seat surface of the valve seat. An elongated member is formed on the valve body so as to extend across the valve hole. The outer surface of the elongated member lies in a plane including the valve seat surface. According to the present invention having the above described structure, bending deformation of the reed piece at the closed state can be deterred.

### BACKGROUND OF THE INVENTION

1. Field of the Invention

The present invention relates to a reed valve for preventing a back-flow of intake air including no fuel, provided within an intake passage of a direct-injection two-cycle engine.

2. Description of Related Art

FIG. 8 is a sectional view of a reed valve used for a two-cycle engine of a type that compresses air-fuel mixture by crankcase-compression. In this reed valve, the base end of each reed piece 39, which is made of resin, is fixed to a metal valve body 38 by a screw 40. The reed pieces 39 open and close valve holes 36 which are provided to the valve body 38. As shown in FIG. 10, which is a side view of the reed valve, a plurality (three in this drawing) of valve holes 36, each having a single opening, are lined in a transverse direction. Three reed pieces 39, each corresponding to one of the valve holes 36, are fixed to a valve seat 37 of the valve body 38. The valve seat surface is covered by a rubber layer 41. Japanese Utility Model Laid-Open Pub. No. 47832/1985 discloses a related technology.

Because of the difference in hardness between the valve seat surface that is covered by the rubber layer 41 and the reed pieces 39 that are made of a resin, it is sometimes possible that a tip 39a of any of the reed piece 39 is damaged by repetitive hits of the tip 39a on the valve seat surface due to the opening/closing operations of the reed piece 39. In order to prevent this phenomenon, the tip 39a is designed to extend from the valve seat surface to a certain degree (about 0.5 to 1 mm), as sectionally shown in FIG. 9. In this way, the tip 39a is placed so as to be away from the valve body 38, and therefore does not touch the valve body 38.

If, however, the reed piece 39 is used to open/close the valve hole 36 formed of the single opening, as shown in FIG. 10, the bending deformation at the closed state (seated state) of the reed piece 39 increases due to the bending load applied to the reed piece 39 by repetitive variations in back pressure while the engine is running. In particular, if the above described reed valve is used in a direct-injection engine in which only air is compressed by crankcase-compression, the temperature of the reed valve rises since there is no fuel vaporization. Therefore, the reed piece 39 made of a resin is softened by the rise in temperature, thereby further increasing the bending deformation at the closed state.

Moreover, in such a case, the tip 39a, which is designed to extend a certain degree from the valve seat surface, is also softened by the rise in temperature. Accordingly, it is likely to be damaged by hitting an exposed end portion 42 of the valve body 38, which is not the area of the valve seat surface and therefore not covered by the rubber layer 41. If the reed valve is placed in an intake passage of air-fuel mixture, the rise in temperature of the reed piece 39 is restricted by fuel vaporization, as mentioned before, and the deformation of the tip 39a is negligible since the hardness thereof is maintained. Therefore, the tip 39a does not hit the exposed end portion 42.

### SUMMARY OF THE INVENTION

Given the above described circumstances, it is an object of the present invention to provide a reed valve of an engine which can deter the bending deformation of reed pieces at the closed state.

In order to achieve the objective, according to the present invention, there is provided a reed valve for opening and closing an intake passage of an engine, comprising: a valve body including a valve hole and a valve seat; and a reed piece made of a resin and having a base end, said base end being supported by said valve body so as to be seated on a valve seat surface of said valve seat; wherein an elongated member is formed on said valve body so as to extend across said valve hole, and wherein an outer surface of said elongated member lies in a plane including said valve seat surface.

According to the above-mentioned structure, when the reed piece is seated on the valve seat, it is supported not only by the valve seat surface but also the elongated member crossing the valvehole. Therefore, bending deformation of the reed piece at the closed state can be deterred.

Preferably, said valve hole is divided by said elongated member into a plurality of opening portions each having a same opening area. Given this structure, since the positional balance of the elongated member is appropriate, bending deformation of the reed piece at the closed state is further deterred.

Moreover, a plurality of said elongated members are preferably formed in a grid pattern. Given this structure, since the reed piece is supported by lattice-like elongated members, bending deformation of the reed piece at the closed state is further deterred.

In addition, said valve seat surface is preferably covered by a rubber layer, and a tip of said reed piece is preferably designed to touch said rubber layer. Given this structure, when the reed valve is used for a direct injection engine in which the temperature of the reed valve itself rises, the tip of the reed valve softened by the rise in temperature does not hit the uncovered portion but hits the valve seat covered by the rubber layer. Therefore, it is possible to prevent the tip of the reed piece from being damaged due to repetitive opening and closing operations.

### BRIEF DESCRIPTION OF THE DRAWINGS

FIG. 1 is a vertical sectional view schematically showing a two-cycle engine equipped with a reed valve according to one embodiment of the present invention.

FIG. 2 is a vertical sectional view showing the reed valve of FIG. 1 which is fixed to the engine.

FIG. 3 is a side view of a valve body of the reed valve of FIG. 1.

FIG. 4 is a plan view of a reed piece of the reed valve of FIG. 1.

FIG. 5 is a partial enlarged vertical sectional view of the reed valve of FIG. 1.

FIG. 6 is a side view of the reed valve of FIG. 1 in which another type of elongated member is used.

FIG. 7 is a side view of the reed valve of FIG. 1 in which still another type of elongated member is used.

FIG. 8 is a vertical sectional view of a conventional reed valve.

FIG. 9 is a partial enlarged vertical sectional view of the reed valve of FIG. 8.

FIG. 10 is a side view of a valve body of the reed valve of FIG. 8.

### DESCRIPTION OF THE PREFERRED EMBODIMENTS

Hereinafter, preferred embodiments of the present invention will be described with reference to the accompanying drawings.

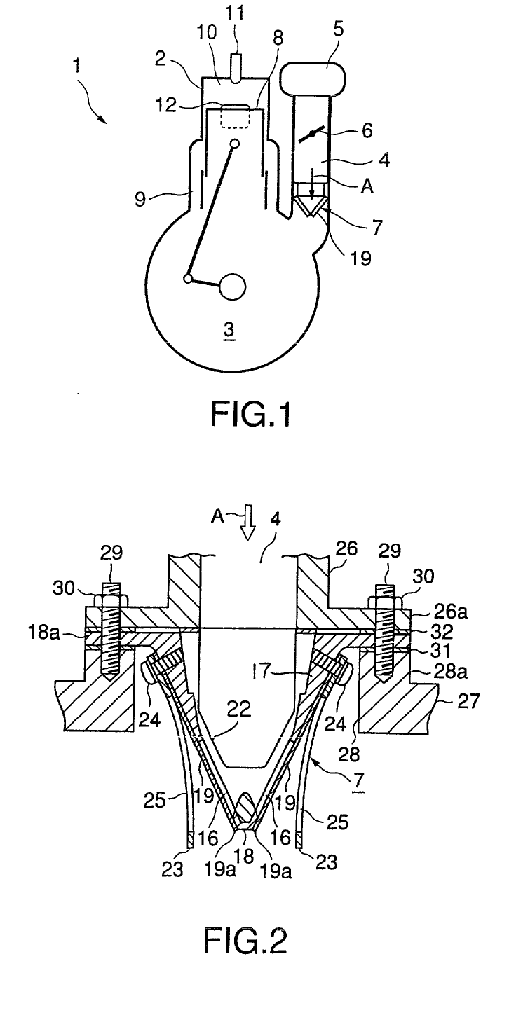

FIG. 1 is a sectional view schematically showing a two-cycle engine equipped with a reed valve according to one embodiment of the present invention. The two-cycle engine 1 is a direct-injection engine in which only air is compressed by crankcase-compression. An intake passage 4 is connected to a crank chamber 3 placed under a cylinder 2. An air cleaner 5 is provided at an inlet of the intake passage 4, and a throttle valve 6 and a reed valve 7 for preventing a back-flow of intake air are provided in the intake passage 4.

In the engine 1, during a rising of a piston 8, air is sucked into the crank chamber 3 via the air cleaner 5 and the intake passage 4, and during a falling of the piston 8, the sucked air is pre-compressed in the crank chamber 3 and supplied to a combustion chamber 10 via a scavenging passage 9. During the rising of the piston 8, the air is further compressed in the combustion chamber 10, and at the point where the piston is near the top dead point, fuel is injected from an injection nozzle 11 into the combustion chamber 10 and burned in the compressed air. As the fuel is burned, the piston 8 falls again, and the combustion gas in the combustion chamber 10 is exhausted from an exhaust port 12 which is opened before the opening of the scavenging passage 9.

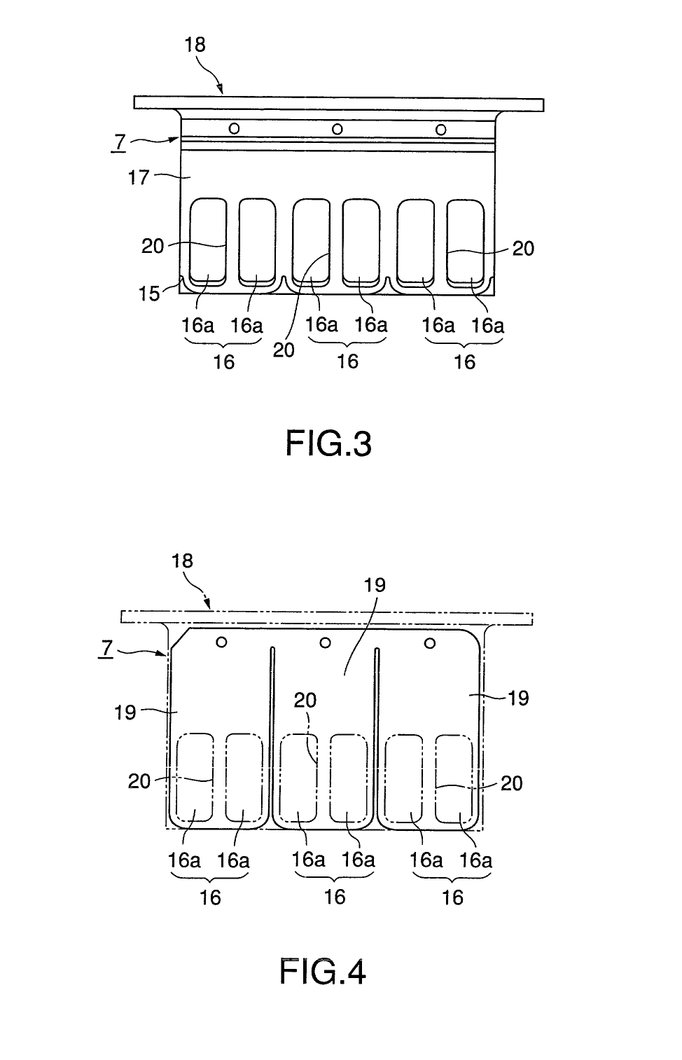

FIG. 2 is a vertical sectional view of the reed valve 7. The reed valve 7 includes a valve body 18 having valve holes 16 forming a part of the intake passage 4 and a valve seat 17, and reed pieces 19 in the shape of thin plates. The base end of the reed pieces 19 are supported by the valve body 18. The reed pieces 19 seat on the valve seat 17. The valve body 18 is made of a metal material such as aluminum, and has a section of an isosceles triangle extending downstream of the intake passage 4. As shown in FIG. 3, a plurality of (in this embodiment, three) valve holes 16 are lined in the transverse directions on both the inclined side portions of the valve body 18. Each valve hole 16 is divided into a plurality of (in this embodiment, two) opening portions 16a by an elongated member 20 which crosses the valve hole 16 in a vertical direction.

The valve seats 17 are formed on the outer sides of the inclined side portions of the valve body 18, on which the valve holes 16 are formed, covering the area including the portions surrounding the valve holes 16. The seat surface, i.e., the outer surface thereof facing the reed pieces 19 is covered by a rubber layer 15 of a nitrile containing resin or the like. The outer surface of the elongated member 20 is designed to lie in a plane including the valve seat surface, and in this embodiment, is also covered by the rubber layer 15 so as to serve as part of the valve seat 17. Within the valve body 18, an air guide member 22 made of a resin is provided, as shown in FIG. 2.

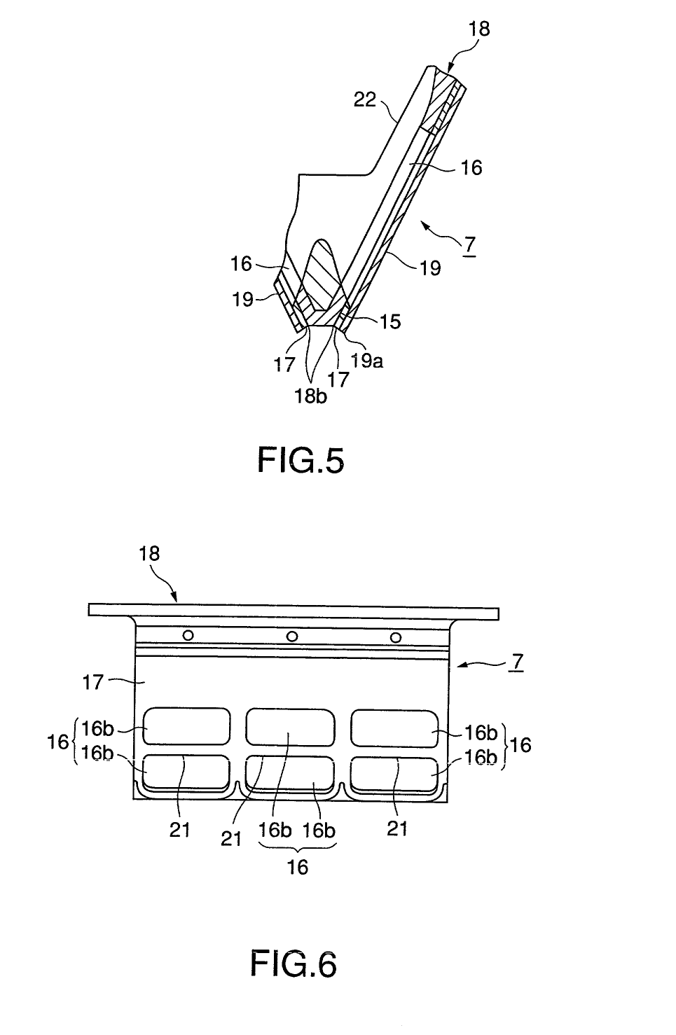

The reed pieces 19 are made of, e.g., an epoxy resin, and the base ends thereof are fixed to the upper side of the side portions of the valve body 18 together with stoppers 23 made of a rigid material, such as a metal, by screws 24 so that the reed pieces 19 are cantilevered. As shown in FIG. 4, the three reed pieces 19 for opening and closing the valve holes 16 on a side portion of the valve body 18 are integrally connected with each other at their base portions. Moreover, as shown in the sectional view of FIG. 5, a tip portion 19a of the reed piece 19 is designed to align with an end of the valve seat covered by the rubber 15 when the reed piece 19 is closed. Accordingly, when the reed piece 19 is closed, the tip 19a touches the rubber layer 15 covering the valve seat surface.

The stopper 23 of FIG. 2 is for setting the maximum opening degree of the reed piece 19, and is curved so that it extends-away from the valve seat surface of the valve body 18 as it goes from the base portion fixed by the screw 24 toward the tip portion. A plurality of slit-like air vents 25 are lined on the stopper 23 in a direction perpendicular to the paper of FIG. 2.

The reed valve 7 is fixed to the intake passage 4 as in the attaching structure depicted in FIG. 2. Specifically, a flange 18a of the valve body 18 is sandwiched between a downstream end flange 26a of a suction pipe 26 forming the intake passage 4 and an opening edge 28a of an inlet 28 of the crankcase 27 forming the crank chamber 3, and the flanges 18a and 26a are fixed to the opening edge 28a of the inlet 28 by tightening a nut 30 received in a stud bolt 29 which is embedded in the opening edge 28a, thereby positioning the reed valve 7 in the intake passage 4. Ring-like sealing members 31 and 32 are provided between the opening edge 28a of the inlet 28 and the flange 18a, and between both the flanges 18a and 26a, respectively, for the sealing of the portion where the reed valve 7 is attached.

Next, the operations of the reed valve 7 will be described. During a rising of the piston 8 of FIG. 1, the reed pieces 19 of FIG. 2 are opened by a negative pressure generated in the crank chamber 3, thereby sucking air, in the direction of the arrow A, into the crank chamber 3 via the air cleaner 5 and a throttle valve 6 provided in the intake passage 4. During a falling of the piston 8, pressure is applied to the inside of the crank chamber 3. Therefore, the reed pieces 19 keep the valve holes 16 in the closed state. While the engine is running, the reed pieces 19 repeat such opening/closing movements. Although a large bending load is applied to the reed pieces 19 due to the repetitive variations in back pressure, which is the pressure of the downstream side of the reed pieces 19, bending deformation of the reed pieces 19 is deterred since at the closed state, the reed pieces 19 are supported by not only the valve seat surface but also the elongated member 20 extending across the valve holes 16 as shown in FIG. 3.

Each valve hole 16 is divided into two opening portions 16a each having the same opening area by the elongated member 20. Such appropriate positional balance of the elongated member 20 further helps to deter the bending deformation of the reed pieces 19 at the closed state.

If the reed valve 7 is used for a direct-injection engine as shown in FIG. 1, the temperature of the reed valve 7 itself rises since there is no fuel vaporization, thereby softening the reed pieces 19 made of a resin. However, in this embodiment, as shown in FIG. 5, the tip portion 19a of the reed piece 19 hits the rubber layer 15 covering the valve seat surface. Therefore, the tip portion 19a is prevented from being damaged due to repetitive opening and closing movements. Specifically, if, as conventionally done, the tip 19a of the reed piece 19 is designed to extend from the rubber layer 15 to a certain degree, the tip 19a of the reed piece 19 softened by the rise in temperature repetitively hits the metal exposing portion 18b of the valve body 18 which is not covered by the rubber layer 15, and this causes the tip 19a to become damaged. However, this does not occur in this embodiment.

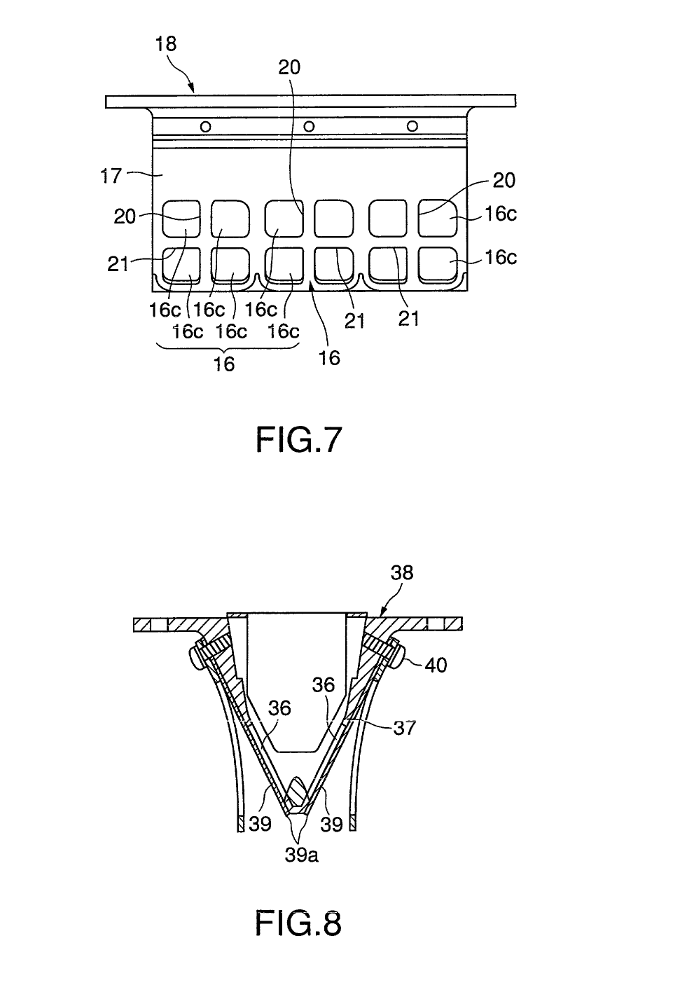

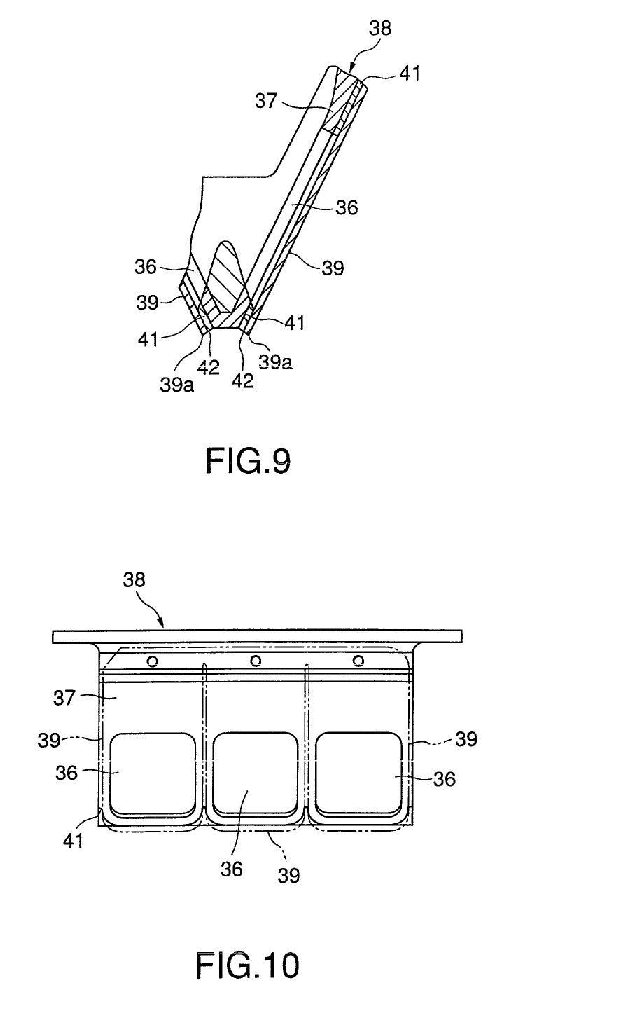

In the above described preferred embodiment, each valve hole 16 shown in FIG. 3 is divided into two opening portions 16a by the elongated member 20 crossing the valve hole 16 in the vertical direction. However, the present invention is not limited to this embodiment, and another type of elongated member 21 crossing the valve hole 16 in a horizontal direction, as shown in FIG. 6, may divide the valve holes 16 into upper and lower opening portions 16b. Moreover, as shown in FIG. 7, elongated members 20 and 21 crossing the valve hole 16 vertically and horizontally may divide each valve hole 16 into four (upper right, upper left, lower right and lower left) opening portions 16c.

Although the preferred embodiments of the present invention have been described in detail, it is apparent that various changes or modifications can be made to such embodiments. Therefore, it should be appreciated that besides the preferred embodiments specifically mentioned above, any kind of embodiment is possible for the present invention without departing from the scope and principle of the invention as set forth in the appended claims.

What is claimed is:

1. A reed valve for opening and closing an intake passage of an engine, comprising:
a valve body including a valve hole and a valve seat; and
a reed piece made of a resin and having a base end, said base end being supported by said valve body so as to be seated on a valve seat surface of said valve seat;
wherein an elongated member is formed on said valve body so as to extend across said valve hole, and
wherein an outer surface of said elongated member lies in a plane including said valve seat surface.

2. The reed valve according to claim 1, wherein said valve hole is divided by said elongated member into a plurality of opening portions each having a same opening area.

3. The reed valve according to claim 1, wherein a plurality of said elongated members are formed in a grid pattern.

4. The reed valve according to claim 1, wherein said valve seat surface is covered by a rubber layer, and
wherein a tip of said reed piece is designed to touch said rubber layer.
